(19) United States
(12) Patent Application Publication
(10) Pub. No.: US 2024/0419403 A1
(43) Pub. Date: Dec. 19, 2024

(54) DEEP LEARNING INFERENCE SYSTEM

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Naoki Miura, Tokyo (JP); Takeshi Sakamoto, Tokyo (JP)

(21) Appl. No.: 18/700,627

(22) PCT Filed: Dec. 7, 2021
(86) PCT No.: PCT/JP2021/044891

§ 371 Date: Apr. 11, 2024

(51) Int. Cl. G06F 7/57; G06N 3/0464

(52) U.S. Cl. CPC G06F 7/57; G06N 3/0464

(57) ABSTRACT

An embodiment is a deep learning inference system including a memory and processors configured to read operation code and parameters from a global memory space of the memory and perform an arithmetic operation of a neural network. The processors are further configured to read processing target data from local memory spaces corresponding to target clients, perform arithmetic operations, and store arithmetic operation results in the local memory spaces corresponding to the target clients.

### CROSS-REFERENCE TO RELATED APPLICATIONS

This application is a national phase entry of PCT Application No. PCT/JP2021/044891, filed on Dec. 7, 2021, which application is hereby incorporated herein by reference.

### TECHNICAL FIELD

The present invention relates to a deep learning inference system that performs inference serving using a multilayer neural network.

### BACKGROUND

In recent years, there have been many services that perform information processing using a multilayer neural network and utilize the results. Obtaining processed data by providing an operation of a neural network arithmetic operation, parameters of the neural network, and processing target data to an arithmetic unit is called inference. Inference requires a large number of operations and memories. Therefore, inference may be performed in a server.

A client transmits a request and processing target data to the server, and receives a result of processing as a response. The provision of such a service is inference serving. Various methods have been proposed for inference serving (refer to Non Patent Literature 1).

In a case in which a field-programmable gate array (FPGA) accelerator is used as an arithmetic unit for inference serving, a method of constructing a von Neumann-type processor on the FPGA accelerator is common (refer to Non Patent Literature 2). A generalized internal structure of the von Neumann-type processor is illustrated in FIG. 5.

Operation code 200 of an arithmetic operation of a neural network, parameters 201 of the neural network, and processing target data are stored in a dynamic random access memory (DRAM) 100. In the example of FIG. 5, the processing target data and data undergoing an arithmetic operation are set as input data 202.

An instruction fetch module 102 reads the operation code 200 from the DRAM 100 and transfers the operation code to a load module 103, a compute module 104, and a store module 105.

The load module 103 reads the input data 202 from the DRAM 100, batches the plurality of pieces of input data 202, and transfers the batched data to the compute module 104.

The compute module 104 performs an arithmetic operation of the neural network using the input data 202 and the parameters 201 according to the operation code 200 transferred from the instruction fetch module 102. An arithmetic logic unit (ALU) 1040 and a general matrix multiply (GEMM) circuit 1041 are mounted on the compute module 104. After performing the arithmetic operation according to the operation code 200, the compute module 104 transfers an arithmetic operation result to the store module 105.

The store module 105 stores the arithmetic operation result from the compute module 104 in the DRAM 100. At this time, not only is the processed data stored in the DRAM 100 as output data 203, but also data undergoing an arithmetic operation is temporarily stored as the output data 203 in some cases. The data undergoing an arithmetic operation is the input data 202 to the load module 103.

The DRAM 100 is a memory outside the processor. The DRAM 100 stores the operation code 200 of the arithmetic operation of the neural network, the parameters 201 of the neural network, the input data 202, and the output data 203 as described above. This data is present for each request client. The memory space of the DRAM 100 in a case in which a memory area is allocated for each request client is as illustrated in FIG. 6. In the example of FIG. 6, each of rows 1000 to 1006 of the memory space schematically represents the memory space for a client.

In a case in which there are a plurality of von Neumann-type processors, there is no memory space shared by respective processors in the memory space of the conventional DRAM 100, and thus there are the following problems.
(I) The processor is not capable of multi-core processing requests from clients.
(II) The processor is not capable of pipeline processing requests from clients.
(III) Even in a case in which requests from clients are the same request (for example, in a case in which parameters are the same), the processor needs to perform reading from the memory for each client, and thus the memory space is wasted.

### CITATION LIST

### Non Patent Literature

Non Patent Literature 1: Christopher Olston, et al., “Tensorflow-serving: Flexible, high-performance ml serving”, Cornell University Library, USA, arXiv preprint arXiv:1712.06139, 2017
Non Patent Literature 2: Thierry Moreau, Tianqi Chen, Luis Ceze, “Leveraging the vta-tvm hardware-software stack for fpga acceleration of 8-bit resnet-18 inference”, Proceedings of the 1st on Reproducible Quality-Efficient Systems Tournament on Co-designing Pareto-efficient Deep Learning, 2018

### SUMMARY

### Technical Problem

The present invention has been made to solve the above problems, and an object thereof is to provide a deep learning inference system capable of improving computer efficiency and executing inference serving with high energy efficiency.

### Solution to Problem

A deep learning inference system of embodiments of the present invention includes: a memory having a global memory space in which operation code of an arithmetic operation of a neural network and parameters of the neural network are stored, and a local memory space secured for each of a plurality of clients that transmit requests; and a plurality of processors configured to perform, for each client, processing of reading the operation code and the parameters from the global memory space and performing an arithmetic operation of the neural network in response to a request from the client, wherein each processor reads processing target data from the local memory space corresponding to a target client, performs an arithmetic operation of the neural network, and stores an arithmetic operation result in the local memory space corresponding to the target client.

Further, a deep learning inference system of embodiments of the present invention includes: a memory having a global memory space in which processing target data of a convolutional neural network is stored and a local memory space secured for each of a plurality of kernels of the convolutional neural network; and a plurality of processors configured to perform, for each of the plurality of kernels, processing of reading the processing target data from the global memory space and performing a convolution operation, wherein each processor reads convolution operation instruction code and kernel parameters of a target kernel from the local memory space corresponding to the target kernel, performs a convolution operation, and stores an arithmetic operation result in the local memory space corresponding to the target kernel.

Further, a deep learning inference system of embodiments of the present invention includes: a memory having a global memory space in which intermediate data of a multilayer neural network is stored and a local memory space secured for each layer of the multilayer neural network; and a plurality of processors configured to perform, for each layer of the multilayer neural network, processing of reading operation code and parameters of an arithmetic operation of a target layer from the local memory space corresponding to the target layer of the multilayer neural network and performing an arithmetic operation of the target layer, wherein a processor for an upper layer among the processors reads processing target data from the local memory space corresponding to the target layer, performs an arithmetic operation of the target layer, and stores an arithmetic operation result in the global memory space as intermediate data, and a processor for a lower layer among the processors reads the intermediate data that is a processing target from the global memory space, performs an arithmetic operation of the target layer, and stores an arithmetic operation result in the local memory space corresponding to the target layer.

Further, a configuration example of the deep learning inference system of the present invention further includes a plurality of cache memories provided between the memory and the plurality of processors and configured to store data, code, and parameters read and written between the memory and the plurality of processors.

### Advantageous Effects of Invention

According to embodiments of the present invention, operation code and parameters are stored in a global memory space shared by a plurality of processors. In embodiments of the present invention, a plurality of inferences can be executed in parallel by different processors for inferences that have different processing target data but use the same model. As a result, in embodiments of the present invention, memory space can be saved and a request throughput can be improved.

### BRIEF DESCRIPTION OF THE DRAWINGS

FIG. 1 is a block diagram illustrating a configuration of an arithmetic unit provided in a server of a deep learning inference system according to a first embodiment of the present invention.

FIG. 2 is a block diagram illustrating a configuration of an arithmetic unit provided in a server of a deep learning inference system according to a second embodiment of the present invention.

FIG. 3 is a block diagram illustrating a configuration of an arithmetic unit provided in a server of a deep learning inference system according to a third embodiment of the present invention.

FIG. 4 is a block diagram illustrating a configuration of an arithmetic unit provided in a server of a deep learning inference system according to a fourth embodiment of the present invention.

FIG. 5 is a block diagram illustrating a configuration of a von Neumann-type processor constructed on an FPGA accelerator.

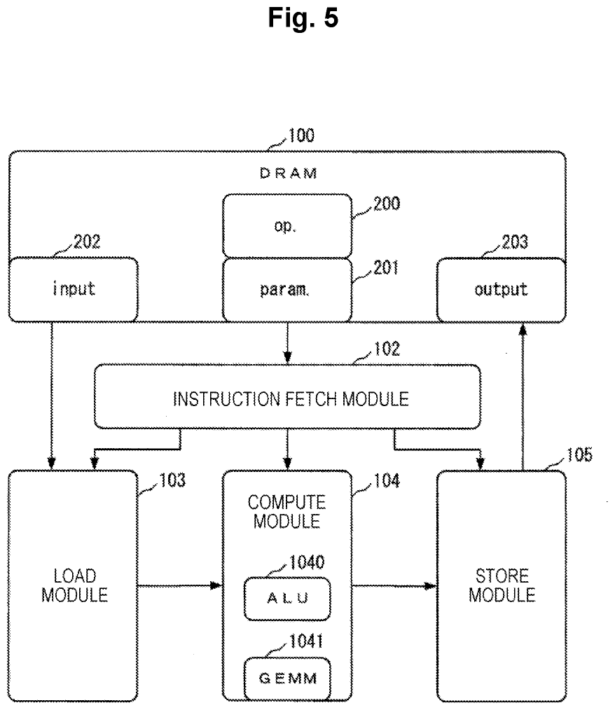

FIG. 6 is a diagram illustrating a memory space of a DRAM accessed by a von Neumann-type processor.

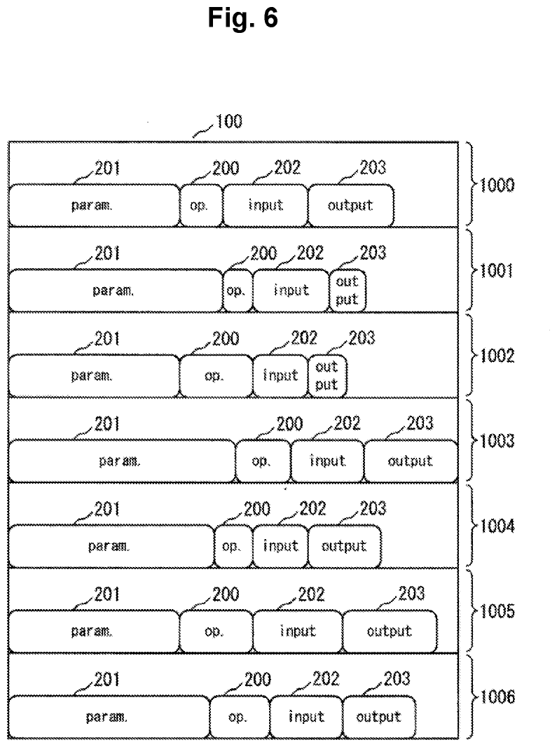

### DETAILED DESCRIPTION OF ILLUSTRATIVE EMBODIMENTS

### Principle of Embodiments of the Invention

The present invention provides a shared memory space in a memory space of a deep learning inference system, and allows von Neumann-type processors to share data.

### First Embodiment

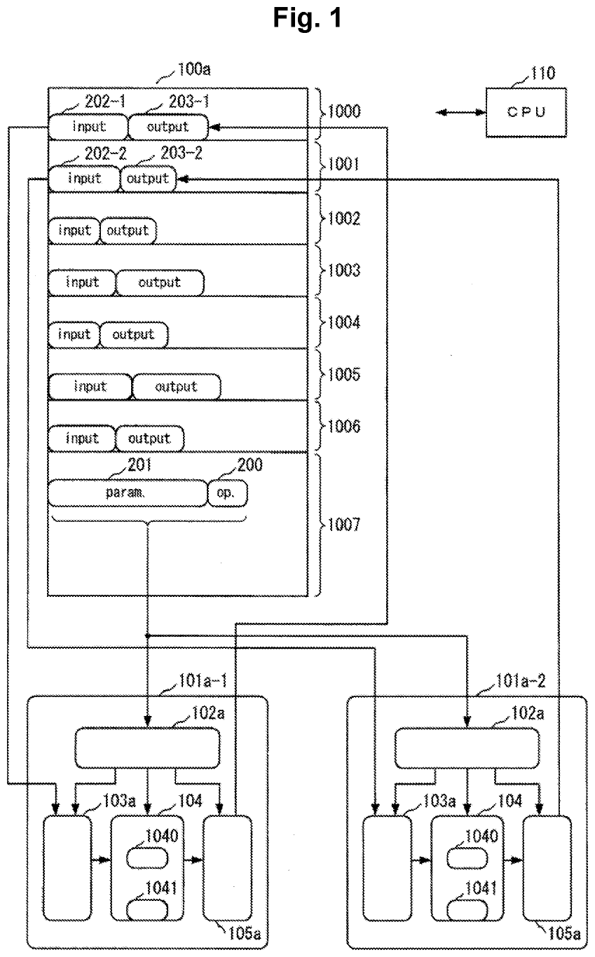

Hereinafter, embodiments of the present invention will be described with reference to the drawings. FIG. 1 is a block diagram illustrating a configuration of an arithmetic unit provided in a server of a deep learning inference system according to a first embodiment of the present invention. The arithmetic unit includes a DRAM 100a and a plurality of von Neumann-type processors 101a-1 and 101a-2. Each of the processors 101a-1 and 101a-2 includes an instruction fetch module 102a, a load module 103a, a compute module 104, and a store module 105a.

The memory space of the DRAM 100a of the present embodiment includes local memory spaces 1000 to 1006 secured for respective clients and a global memory space 1007 secured for sharing by the plurality of processors 101a-1 and 101a-2.

When an inference request is received from a client A via a network, a central processing unit (CPU) 110 of a server stores operation code 200 of an arithmetic operation of a neural network corresponding to the inference request and parameters 201 of the neural network in the global memory space 1007 of the DRAM 100a. Further, the CPU 110 stores processing target data received from the client A as input data 202-1 in the local memory space 1000 of the DRAM 100a corresponding to the client A.

Further, when an inference request and processing target data are received from a client B via the network, the CPU 110 stores the processing target data as input data 202-2 in the local memory space 1001 of the DRAM 100a corresponding to the client B. An inference request designates which model is used for inference. In the present embodiment, it is assumed that the inference requests received from the clients A and B designate the same model.

The instruction fetch module 102a of the processor 101a-1 reads the operation code 200 and the parameters 201 from the global memory space 1007 of the DRAM 100a, and transfers them to the load module 103a, the compute module 104, and the store module 105a of the processor 101a-1.

The load module 103a of the processor 101a-1 reads the input data 202-1 from the local memory space 1000 of the DRAM 100a corresponding to the client A that has transmitted the inference request has been received, batches the plurality of pieces of input data 202-1, and transfers the batched data to the compute module 104.

The compute module 104 of the processor 101a-1 performs an arithmetic operation of the neural network using the input data 202-1 and the parameters 201 according to the operation code 200 transferred from the instruction fetch module 102a. The compute module 104 transfers the arithmetic operation result to the store module 105a.

The store module 105a of the processor 101a-1 stores the arithmetic operation result from the compute module 104 in the local memory space 1000 of the DRAM 100a corresponding to the client A as output data 203-1.

The CPU 110 of the server reads processed data from the local memory space 1000 of the DRAM 100a, and returns the data to the client A as a response to the inference request.

On the other hand, the instruction fetch module 102a of the processor 101a-2 reads the operation code 200 and the parameters 201 from the global memory space 1007 of the DRAM 100a, and transfers them to the load module 103a, the compute module 104, and the store module 105a of the processor 101a-2.

The load module 103a of the processor 101a-2 reads the input data 202-2 from the local memory space 1001 of the DRAM 100a corresponding to the client B that has transmitted the inference request, batches the plurality of pieces of input data 202-2, and transfers the batched data to the compute module 104.

The compute module 104 of the processor 101a-2 performs an arithmetic operation of the neural network using the input data 202-2 and the parameters 201 according to the operation code 200 transferred from the instruction fetch module 102a. The compute module 104 transfers the arithmetic operation result to the store module 105a.

The store module 105a of the processor 101a-2 stores the arithmetic operation result from the compute module 104 in the local memory space 1001 of the DRAM 100a corresponding to the client B as output data 203-2.

The CPU 110 of the server reads processed data from the local memory space 1001 of the DRAM 100a, and returns the data to the client B as a response to the inference request.

As described above, in the present embodiment, the operation code 200 and the parameters 201 are stored in the global memory space 1007 shared by the plurality of processors 101a-1 and 101a-2. In the present embodiment, a plurality of inferences can be executed in parallel by the different processors 101a-1 and 101a-2 for inferences that have different pieces of processing target data but use the same model (inferences using the same operation code 200). As a result, in the present embodiment, the memory space can be saved, and the request throughput can be improved.

### Second Embodiment

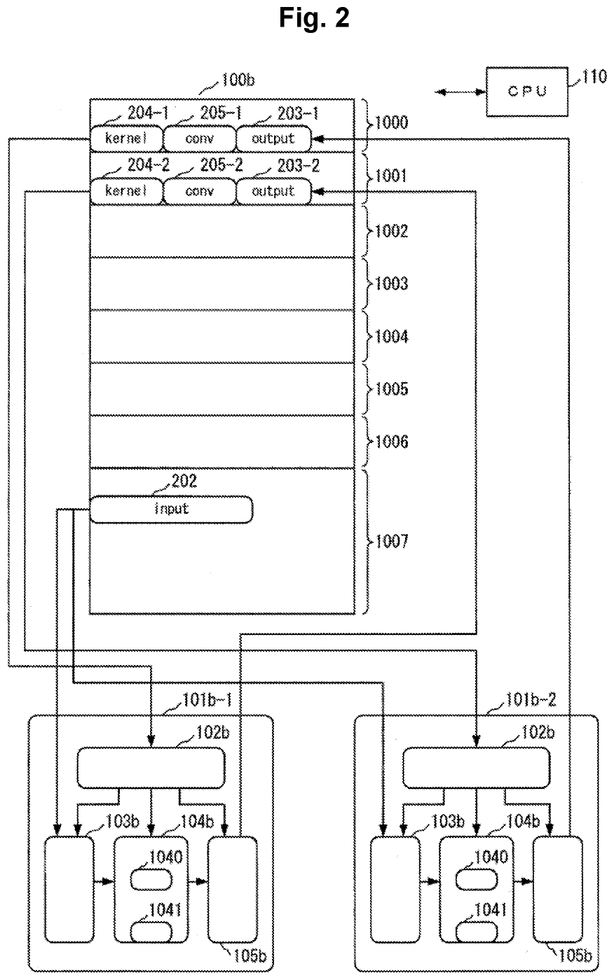

Next, a second embodiment of the present invention will be described. FIG. 2 is a block diagram illustrating a configuration of an arithmetic unit provided in a server of a deep learning inference system according to the second embodiment of the present invention. The arithmetic unit includes a DRAM 100b and a plurality of von Neumann-type processors 101b-1 and 101b-2. Each of the processors 101b-1 and 101b-2 includes an instruction fetch module 102b, a load module 103b, a compute module 104b, and a store module 105b.

In the case of a convolutional neural network, a convolution operation is performed with a plurality of types of filters (kernels), and arithmetic operation of a weighted sum of a plurality of convolution operation results is performed.

The memory space of the DRAM 100b of the present embodiment includes local memory spaces 1000 to 1006 secured for a plurality of types of kernels of a convolutional neural network and a global memory space 1007 secured for sharing by the plurality of processors 101b-1 and 101b-2. In the global memory space 1007, input data 202 of a convolution operation is stored by the CPU 110 of the server.

The instruction fetch module 102b of the processor 101b-1 reads a kernel parameter 204-1 and a convolution arithmetic operation instruction code 205-1 of the kernel from the local memory space 1000 of the DRAM 100b, and transfers them to the load module 103b, the compute module 104b, and the store module 105b of the processor 101b-1.

The load module 103b of the processor 101b-1 reads the input data 202 from the global memory space 1007 of the DRAM 100b and transfers the input data to the compute module 104b.

The compute module 104b of the processor 101b-1 performs a convolution operation using the input data 202 and kernel parameters 204-1 according to convolution operation instruction code 205-1 transferred from the instruction fetch module 102b. The compute module 104b transfers the arithmetic operation result to the store module 105b.

The store module 105b of the processor 101b-1 stores the arithmetic operation result from the compute module 104b as output data 203-1 in the local memory space 1000 of the DRAM 100b.

On the other hand, the instruction fetch module 102b of the processor 101b-2 reads kernel parameters 204-2 and convolution arithmetic operation instruction code 205-2 of the kernel from the local memory space 1001 of the DRAM 100b, and transfers them to the load module 103b, the compute module 104b, and the store module 105b of the processor 101b-2.

The load module 103b of the processor 101b-2 reads the input data 202 from the global memory space 1007 of the DRAM 100b and transfers the input data to the compute module 104b.

The compute module 104b of the processor 101b-2 performs a convolution operation using the input data 202 and the kernel parameters 204-2 according to the convolution operation instruction code 205-2 transferred from the instruction fetch module 102b. The compute module 104b transfers the arithmetic operation result to the store module 105b.

The store module 105b of the processor 101b-2 stores the arithmetic operation result from the compute module 104b as output data 203-2 in the local memory space 1001 of the DRAM 100b.

As described above, in the present embodiment, the input data 202 is stored in the global memory space 1007 shared by the plurality of processors 101b-1 and 11b-2, and the kernel parameters 204-1 and 204-2 and the convolution operation instruction code 205-1 and 205-2 are stored in different local memory spaces 1000 to 1006 for each convolution operation. As a result, in the present embodiment, a plurality of convolution operations can be executed in parallel by the different processors 101b-1 and 101b-2, and the inference throughput can be improved.

### Third Embodiment

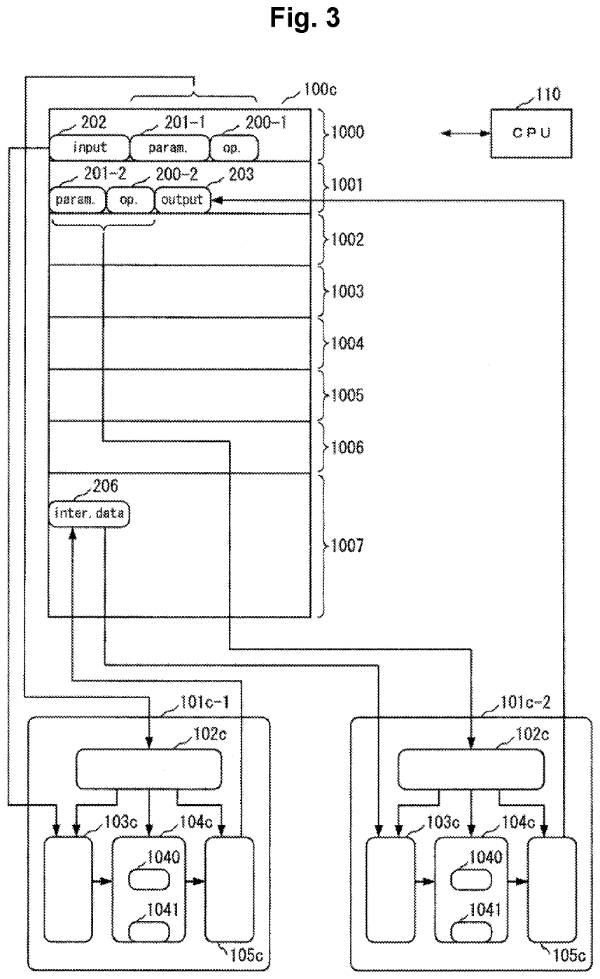

Next, a third embodiment of the present invention will be described. FIG. 3 is a block diagram illustrating a configuration of an arithmetic unit provided in a server of a deep learning inference system according to the third embodiment of the present invention. The arithmetic unit includes a DRAM 100c and a plurality of von Neumann-type processors 101c-1 and 101c-2. Each of the processors 101c-1 and 101c-2 includes an instruction fetch module 102c, a load module 103c, a compute module 104c, and a store module 105c.

In the case of a multilayer neural network, pipeline processing can be performed by performing an arithmetic operation of an upper layer by the processor 101c-1 and performing an arithmetic operation of a lower layer by the processor 101c-2. The memory space of the DRAM 100c of the present embodiment includes local memory spaces 1000 to 1006 secured for respective layers of the multilayer neural network and a global memory space 1007 secured for sharing by the plurality of processors 101c-1 and 101c-2.

The CPU 110 of the server stores operation code 200-1 and parameters 201-1 of the arithmetic operation of the upper layer of the multilayer neural network in the local memory space 1000 of the DRAM 100c and stores operation code 200-2 and parameters 201-2 of the arithmetic operation of the lower layer in the local memory space 1001 of the DRAM 100c. Further, the CPU 110 stores processing target data received from a client in the local memory space 1000 as input data 202.

The instruction fetch module 102c of the processor 101c-1 reads the operation code 200-1 and the parameters 201-1 from the local memory space 1000 of the DRAM 100c, and transfers them to the load module 103c, the compute module 104c, and the store module 105c of the processor 101c-1.

The load module 103c of the processor 101c-1 reads the input data 202 from the local memory space 1000 of the DRAM 100c and transfers the input data to the compute module 104c.

The compute module 104c of the processor 101c-1 performs the arithmetic operation of the upper layer of the multilayer neural network using the input data 202 and the parameters 201-1 according to the operation code 200-1 transferred from the instruction fetch module 102c. The compute module 104c transfers the arithmetic operation result to the store module 105c.

The store module 105c of the processor 101c-1 stores the arithmetic operation result from the compute module 104c as intermediate data 206 in the global memory space 1007 of the DRAM 100c.

Next, the instruction fetch module 102c of the processor 101c-2 reads the operation code 200-2 and the parameters 201-2 from the local memory space 1001 of the DRAM 100c, and transfers them to the load module 103c, the compute module 104c, and the store module 105c of the processor 101c-2.

The load module 103c of the processor 101c-2 reads the intermediate data 206 from the global memory space 1007 of the DRAM 100c and transfers the intermediate data to the compute module 104c.

The compute module 104c of the processor 101c-2 performs the arithmetic operation of the lower layer of the multilayer neural network using the intermediate data 206 and the parameters 201-2 according to the operation code 200-2 transferred from the instruction fetch module 102c. The compute module 104c transfers the arithmetic operation result to the store module 105c.

The store module 105c of the processor 101c-2 stores the arithmetic operation result from the compute module 104c in the local memory space 1001 of the DRAM 100c as output data 203.

As described above, in the present embodiment, the intermediate data 206 of the arithmetic operation of the multilayer neural network is stored in the global memory space 1007 shared by the plurality of processors 101c-1 and 101c-2. As a result, in the present embodiment, it is possible to perform pipeline processing of arithmetic operations of the multilayer neural network, and the inference throughput can be improved.

### Fourth Embodiment

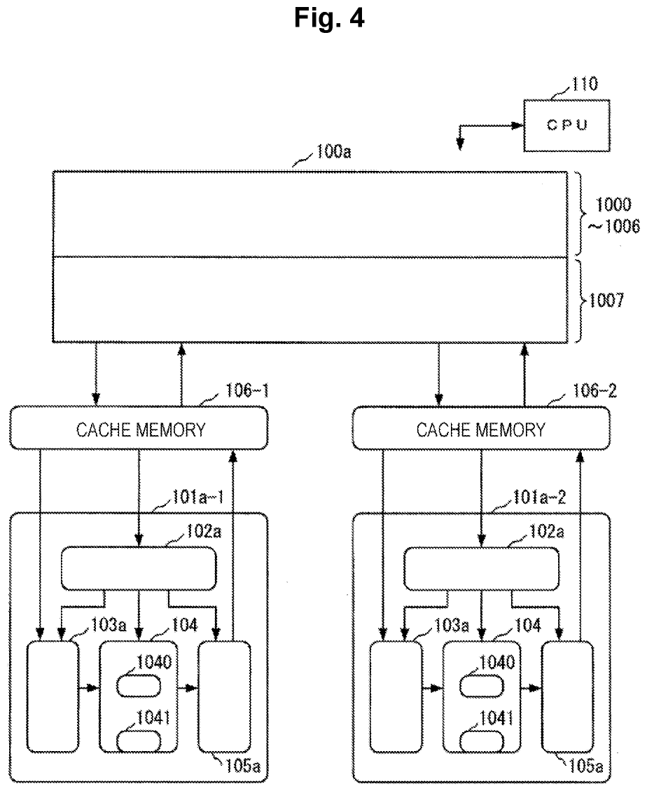

Next, a fourth embodiment of the present invention will be described. FIG. 4 is a block diagram illustrating a configuration of an arithmetic unit provided in a server of a deep learning inference system according to the fourth embodiment of the present invention. The arithmetic unit includes a DRAM 100a, a plurality of von Neumann-type processors 101a-1 and 101a-2, and cache memories 106-1 and 106-2 provided between the DRAM 100a and the processors 101a-1 and 101a-2.

The DRAM 100a is as described in the first embodiment. The CPU 110 of the server stores the operation code 200 and the parameters 201 stored in the global memory space 1007 of the DRAM 100a in the cache memories 106-1 and 106-2. Further, the CPU 110 stores the input data 202-1 stored in the local memory space 1000 of the DRAM 100a in the cache memory 106-1 and stores the input data 202-2 stored in the local memory space 1001 of the DRAM 100a in the cache memory 106-2.

The instruction fetch module 102a of the processor 101a-1 reads the operation code 200 and the parameters 201 from the cache memory 106-1 and transfers the read operation code and parameter to the load module 103a, the compute module 104, and the store module 105a of the processor 101a-1.

The load module 103a of the processor 101a-1 reads the input data 202-1 from the cache memory 106-1, batches the plurality of pieces of input data 202-1, and transfers the batched data to the compute module 104.

The compute module 104 of the processor 101a-1 performs an arithmetic operation of the neural network using the input data 202-1 and the parameters 201 according to the operation code 200 transferred from the instruction fetch module 102a.

The store module 105a of the processor 101a-1 stores the arithmetic operation result from the compute module 104 in the cache memory 106-1.

The CPU 110 of the server writes the processed data stored in the cache memory 106-1 to the local memory space 1000 of the DRAM 100a corresponding to the client A, reads the processed data from the local memory space 1000, and returns the processed data to the client A.

On the other hand, the instruction fetch module 102a of the processor 101a-2 reads the operation code 200 and the parameters 201 from the cache memory 106-2, and transfers them to the load module 103a, the compute module 104, and the store module 105a of the processor 101a-2.

The load module 103a of the processor 101a-2 reads the input data 202-2 from the cache memory 106-2, batches the plurality of pieces of input data 202-2, and transfers the batched data to the compute module 104.

The compute module 104 of the processor 101a-2 performs an arithmetic operation of the neural network using the input data 202-2 and the parameters 201 according to the operation code 200 transferred from the instruction fetch module 102a.

The store module 105a of the processor 101a-2 stores the arithmetic operation result from the compute module 104 in the cache memory 106-2.

The CPU 110 of the server writes the processed data stored in the cache memory 106-2 to the local memory space 1001 of the DRAM 100a corresponding to the client B, reads the processed data from the local memory space 1001, and returns the processed data to the client B.

As described above, in the present embodiment, it is possible to conceal the memory latency of the DRAM 100a and shorten the inference latency by providing the cache memories 106-1 and 106-2 between the DRAM 100a and the processors 101a-1 and 101a-2.

Although an example in which the cache memories 106-1 and 106-2 are applied to the first embodiment has been described in the present embodiment, it goes without saying that the cache memories may be applied to the second and third embodiments.

In a case in which the cache memories 106-1 and 106-2 are applied to the second embodiment, the input data 202, the kernel parameters 204-1, the convolution operation instruction code 205-1, and the output data 203-1 may be stored in the cache memory 106-1, and the input data 202, the kernel parameters 204-2, the convolution operation instruction code 205-2, and the output data 203-2 may be stored in the cache memory 106-2.

In a case in which the cache memories 106-1 and 106-2 are applied to the third embodiment, the input data 202, the operation code 200-1, and the parameters 201-1 may be stored in the cache memory 106-1, and the operation code 200-2, the parameters 201-2, the intermediate data 206, and the output data 203 may be stored in the cache memory 106-2.

Further, the number of von Neumann-type processors and the number of cache memories are two in the first to fourth embodiments, it goes without saying that the numbers may be three or more.

### INDUSTRIAL APPLICABILITY

The present invention can be applied to technology for providing a service using a neural network.

### REFERENCE SIGNS LIST

100a, 100b, 100c DRAM,
101a-1, 101a-2, 101b-1, 101b-2, 101c-1, 101c-2 Von Neumann-type processor
102a, 102b, 102c Instruction fetch module
103a, 103b, 103c Load module
104, 104b, 104C Compute module
105a, 105b, 105c Store module
106-1, 106-2 Cache memory
1000 to 1006 Local memory space
1007 Global memory space

1-4. (canceled)

5. A deep learning inference system comprising:
a memory having a global memory space configured to store an operation code of an arithmetic operation of a neural network and parameters of the neural network, and a local memory space secured for each client that transmits requests;
a plurality of processors; and
a storage device storing a program to be executed by the plurality of processors, the program including instructions for:
performing, for each of a plurality of clients, processing of reading the operation code and the parameters from the global memory space;
performing an arithmetic operation of the neural network in response to a request from the client;
reading processing target data from the local memory space corresponding to a target client; and
storing an arithmetic operation result in the local memory space corresponding to the target client.

6. The deep learning inference system of claim 5, wherein the plurality of processors comprise a plurality of von Neumann-type processors, each processor including an instruction fetch module, a load module, a compute module, and a store module.

7. The deep learning inference system of claim 6, wherein each von Neumann-type processor is configured to execute inferences in parallel for inferences that have different processing target data but use a same model.

8. The deep learning inference system of claim 6, wherein each von Neumann-type processor includes an instruction fetch module configured to read the operation code and parameters from the global memory space of the memory.

9. The deep learning inference system of claim 8, wherein each von Neumann-type processor includes a load module configured to read the processing target data from a corresponding local memory space of the memory.

10. The deep learning inference system of claim 9, wherein each von Neumann-type processor includes a compute module configured to perform an arithmetic operation of the neural network using the processing target data and the parameters according to the operation code.

11. The deep learning inference system of claim 10, wherein each von Neumann-type processor includes a store module configured to store an arithmetic operation result in a corresponding local memory space of the memory.

12. A deep learning inference system comprising:
a memory having a global memory space configured to store processing target data of a convolutional neural network and a local memory space secured for each of a plurality of kernels of the convolutional neural network; and
a plurality of processors configured to perform, for each of the plurality of kernels, processing of reading the processing target data from the global memory space and performing a convolution operation,
wherein each processor is configured to read convolution operation instruction code and kernel parameters of a target kernel from the local memory space corresponding to the target kernel, perform a convolution operation, and store an arithmetic operation result in the local memory space corresponding to the target kernel.

13. A deep learning inference system, comprising:
a dynamic random access memory (DRAM) having a global memory space and a plurality of local memory spaces;
a plurality of von Neumann-type processors, each processor including an instruction fetch module, a load module, a compute module, and a store module; and
a central processing unit (CPU);
a storage device storing a program to be executed by the CPU, the program including instructions for:
storing operation code and parameters of an upper layer of a multilayer neural network in a first local memory space of the DRAM designated for upper layer processing,
storing operation code and parameters of a lower layer of the multilayer neural network in a second local memory space of the DRAM designated for lower layer processing, and
storing intermediate data resulting from an arithmetic operation of the upper layer of the multilayer neural network in the global memory space of the DRAM,
wherein the von Neumann-type processors are configured to access the global memory space to retrieve the intermediate data for processing by the lower layer of the multilayer neural network.

14. The deep learning inference system according claim 13, further comprising a plurality of cache memories provided between the DRAM and the plurality of von Neumann-type processors and configured to store data, code, and parameters read and written between the memory and the plurality of von Neumann-type processors.

15. The deep learning inference system according to claim 13, wherein a von Neumann-type processor for an upper layer among the plurality of von Neumann-type processors is configured to read processing target data from the local memory space corresponding to a target layer, perform an arithmetic operation of the target layer, and store an arithmetic operation result in the global memory space as intermediate data, and
a von Neumann-type processor for a lower layer among the plurality of von Neumann-type processors is configured to read the intermediate data that is a processing target from the global memory space, perform an arithmetic operation of the target layer, and store an arithmetic operation result in the local memory space corresponding to the target layer.
